(19) United States
(12) Patent Application Publication
(10) Pub. No.: US 2026/0178260 A1
(43) Pub. Date: Jun. 25, 2026

(54) RENDERING AUDIO CAPTURED WITH MULTIPLE DEVICES

(71) Applicant: Dolby Laboratories Licensing Corporation, San Francisco, CA (US)

(72) Inventors: Yuanxing MA, Beijing (CN); Zhiwei SHUANG, Beijing (CN); Yang LIU, Beijing (CN)

(73) Assignee: Dolby Laboratories Licensing Corporation, San Francisco, CA (US)

(21) Appl. No.: 19/103,755

(22) PCT Filed: Aug. 21, 2023
(86) PCT No.: PCT/US2023/030652

§ 371 Date: Feb. 13, 2025

Related U.S. Application Data
(60) Provisional application No. 63/432,385, filed on Dec. 14, 2022.
(60) Provisional application No. 63/509,121, filed on Jun. 20, 2023.

(30) Foreign Application Priority Data
Aug. 24, 2022 (WO) PCT/CN2022/114596

(51) Int. Cl. G06F 3/16

(52) U.S. Cl. CPC G06F 3/165

(57) ABSTRACT

A method of audio processing includes receiving user-generated content having two audio sources, extracting audio objects and a residual signal, adjusting the audio objects and the residual signal according to the listener's head movements, and mixing the adjusted audio signals to generate a binaural audio signal. In this manner, the binaural signal adjusts according to the listener's head movements without requiring perfect audio objects.

### CROSS REFERENCE TO RELATED APPLICATIONS

This application claims the benefit of priority to International Patent Application No. PCT/CN2022/114596 filed Aug. 24, 2022, U.S. Provisional Patent Application No. 63/432,385 filed Dec. 14, 2022 and U.S. Provisional Patent Application No. 63/509,121 filed Jun. 20, 2023, each of which is incorporated by reference in its entirety.

### FIELD

The present disclosure relates to audio processing, and in particular, to processing audio that is captured by binaural microphones and additional microphones.

### BACKGROUND

Unless otherwise indicated herein, the approaches described in this section are not prior art to the claims in this application and are not admitted to be prior art by inclusion in this section.

Devices for audiovisual capture are becoming more popular with consumers. Such devices include portable cameras such as the Sony Action Cam™ camera and the GoPro™ camera, as well as mobile telephones with integrated camera functionality. Generally, the device captures audio concurrently with capturing the video, for example by using monaural or stereo microphones. Audiovisual content sharing systems, such as the YouTube™ service and the Twitch.tv™ service, are growing in popularity as well. The user uploads the captured audiovisual content to the content sharing system, or broadcasts the captured audiovisual content concurrently with the capturing. Because this content is generated by the users, it is referred to as user generated content (UGC), in contrast to professionally generated content (PGC) that is typically generated by professionals. UGC often differs from PGC in that UGC is created using consumer equipment that may be less expensive and have fewer features than professional equipment. Another difference between UGC and PGC is that UGC is often captured in an uncontrolled environment, such as outdoors, whereas PGC is often captured in a controlled environment, such as a recording studio.

Another difference between UGC and PGC is that PGC may use perfect audio objects, whereas UGC may not. For example, a PGC content creator may position high-resolution audio at a specific object location and the PGC system may generate an audio object that exactly corresponds to the content creator's intent; this audio object is referred to as a perfect audio object. In contrast, a UGC content creator is generally unable to use perfect audio objects.

Binaural audio includes audio that is recorded using two microphones located at a user's ear positions. The captured binaural audio, which may be referred to as immersive audio, results in an immersive listening experience when replayed via headphones. As compared to stereo audio, binaural audio also includes the head shadow of the user's head and ears, resulting in interaural time differences and interaural level differences as the binaural audio is captured. Binaural audio also differs from stereo in that stereo audio may involve loudspeaker crosstalk between the loudspeakers. PGC binaural audio may be captured in a studio environment that has controllable sound sources and acoustics. UGC binaural audio may be captured by earbuds and may include unwanted sound from the surrounding environment.

Head tracking (or headtracking) generally refers to tracking the orientation of a user's head to adjust the input to, or output of, a system. For audio, headtracking refers to changing an audio signal according to the head orientation of a listener.

### SUMMARY

Existing audiovisual capture systems for UGC have a number of issues. One issue is that UGC often does not use perfect audio objects, because the consumer capture devices often cannot capture perfect audio objects. Another issue is that generally a UGC content creator can capture audiovisual content using a mobile telephone, or may capture binaural audio content using binaural earbuds; however, there is no good way for the UGC content creator to integrate the outputs of these two devices.

In view of these issues, embodiments relate to processing audio from multiple sources and adjusting the audio based on the listener's head movements.

According to an embodiment, a computer-implemented method of audio processing includes receiving, by one or more playback devices, user generated content (UGC) captured by capture devices that are connected to one another. Each audio source of the UGC corresponds to respective characteristics in an audio scene. The method further includes receiving, by the one or more playback devices from one or more sensors of the one or more playback devices, information indicating listener behavior of a user of the one or more playback devices. The listener behavior may include the listener's head movements. The method further includes adapting the UGC according to the listener behavior, including compensating the characteristics of audio sources according to the listener behavior. The method further includes rendering the adapted UGC to provide an interactive experience to the listener with regard to the audio scene.

As a result, the output audio is responsive to the listener's head movements even for user generated content, without requiring perfect audio objects or professionally generated content.

According to another embodiment, an apparatus includes a processor. The processor is configured to control the apparatus to implement one or more of the methods described herein. The apparatus may additionally include similar details to those of one or more of the methods described herein.

According to another embodiment, a non-transitory computer readable medium stores a computer program that, when executed by a processor, controls an apparatus to execute processing including one or more of the methods described herein.

The following detailed description and accompanying drawings provide a further understanding of the nature and advantages of various implementations.

### BRIEF DESCRIPTION OF THE DRAWINGS

FIGS. 1A-1B are views of a user with UGC capture devices.

FIG. 2 is a block diagram of a system 200 for interactive rendering of UGC captured with multiple devices.

FIG. 3 is a block diagram showing additional details of the HRTF adjuster 220 (see FIG. 2).

FIG. 4 is a block diagram showing additional details of the rebalancer 230 (see FIG. 2).

FIG. 5 is a block diagram showing additional details of the mixer 240 (see FIG. 2).

FIG. 6 is a device architecture 600 for implementing the features and processes described herein, according to an embodiment.

FIG. 7 is a flowchart of a method 700 of audio processing.

### DETAILED DESCRIPTION

Described herein are techniques related to audio processing. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

In the following description, various methods, processes and procedures are detailed. Although particular steps may be described in a certain order, such order is mainly for convenience and clarity. A particular step may be repeated more than once, may occur before or after other steps, even if those steps are otherwise described in another order, and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive- or is intended, such will be specifically noted, e.g. “either A or B”, “at most one of A and B”, etc.

This document describes various processing functions that are associated with structures such as blocks, elements, components, circuits, etc. In general, these structures may be implemented by a processor that is controlled by one or more computer programs.

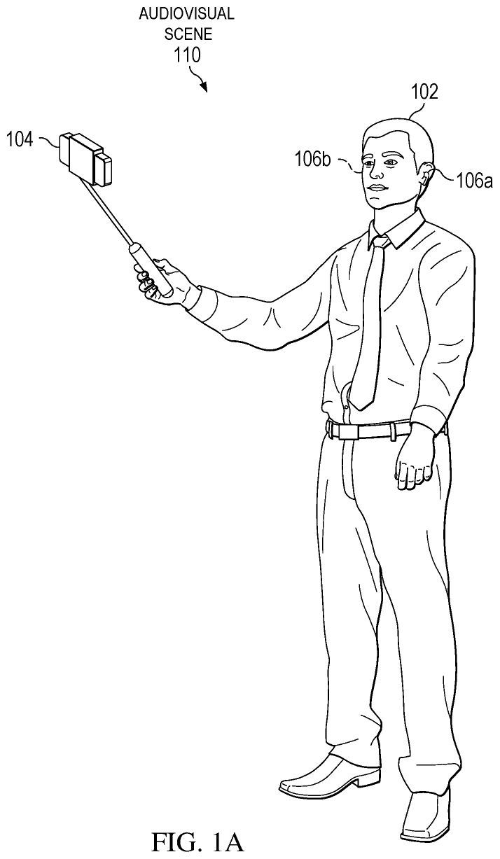

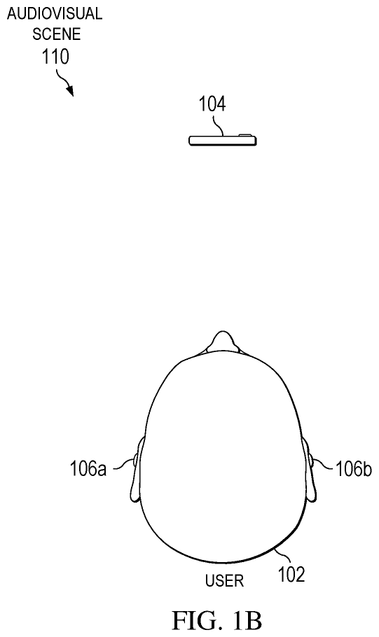

FIGS. 1A-1B are views of a user with UGC capture devices. FIG. 1A is a side perspective view, and FIG. 1B is an overhead view. FIGS. 1A-1B show a user 102 holding a mobile telephone 104 and wearing earbuds 106a and 106b (collectively 106). The mobile telephone 104 generally includes a camera, microphones, a screen, loudspeakers, a processor, volatile and non-volatile memory and storage, radios, and other components. Examples of the mobile telephone 104 include the Apple iPhone™ mobile telephone, the Samsung Galaxy™ mobile telephone, etc. The earbuds 106 may connect to the mobile telephone 104 wirelessly, for example via the IEEE 802.15.1 standard protocol, such as the Bluetooth™ protocol. The earbuds 106 generally include loudspeakers, microphones, a processor, volatile and non-volatile memory and storage, radios, and other components.

The user 102 uses these devices to capture UGC of the surrounding environment, referred to as the audiovisual scene 110. The user 102 may hold the mobile telephone 104 in hand or on a selfie stick in order to capture the UGC; for example, using the telephone's screen (on the front, facing the user) to frame a video scene in front of the user, using telephone's camera (on the rear, facing the video scene) to capture the video, and using the telephone's microphones to capture audio (e.g., a single microphone captures monaural audio, two microphones capture stereo audio, etc.). The user may use the earbuds 106 to capture binaural audio of the audiovisual scene 110 concurrently with capturing the audio and video using the mobile telephone 104.

As discussed in the background, there is no easy way for existing UGC devices to integrate the outputs of these two devices, especially as both are capturing audio. For example, when playing back the content, a listener may have to choose between the audio captured by the mobile telephone 104 (which is not binaural audio) and the binaural audio captured by the earbuds 106. Subsequent sections describe how the system described herein integrates these two audio sources. As another example, a listener may themselves have earbuds with headtracking capability, but there is no easy way to adjust the captured UGC binaural audio to account for the listener's head movements. Subsequent sections also describe how the system described herein addresses this issue.

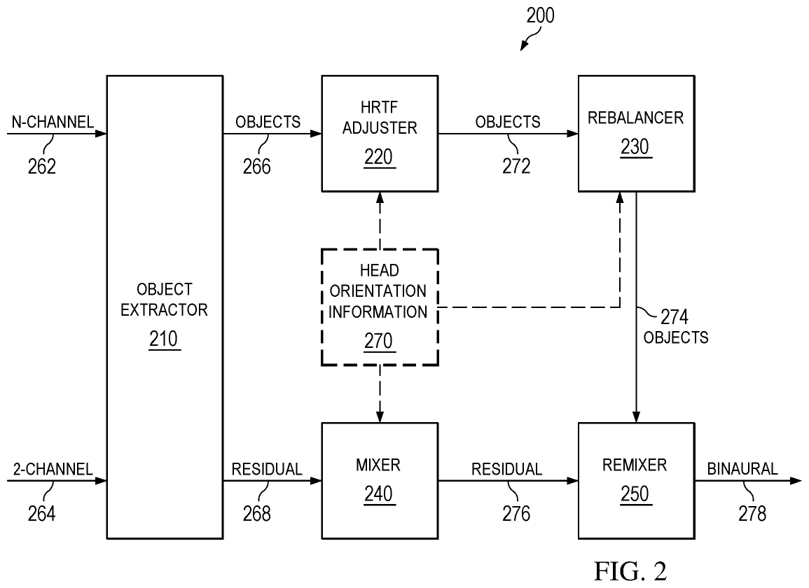

FIG. 2 is a block diagram of a system 200 for interactive rendering of UGC captured with multiple devices. The system 200 may be implemented using multiple devices, including two or more capture devices (e.g., earbuds and a mobile telephone), a server device, a playback device, etc. The devices that implement the system 200 may include circuits such as a microprocessor that execute computer programs that implement the functionalities of the system 200. The system 200 includes an object extractor 210, a head-related transfer function (HRTF) adjuster 220, a rebalancer 230, a mixer 240, and a remixer 250.

The object extractor 210 receives an audio signal 262 and a binaural audio signal 264, performs object extraction, and generates one or more binaural objects 266 and a residual signal 268. The audio signal 262 is captured by a UGC audiovisual capture device such as a mobile telephone, where the audio signal 262 is captured concurrently with video data. The audio signal 262 has N channels that generally correspond to the number of microphones of the UGC audiovisual capture device. For example, the audio signal 262 may have 1 channel for captured monaural audio, 2 channels for captured stereo audio, etc. A mobile telephone used to capture the audio signal 262 may have two microphones (e.g., at the bottom and top, at the left and right, at the back and front, etc.), three microphones (at the bottom, top, left, right, front, rear, or an omnidirectional microphone, etc.), etc. The binaural audio signal 264 is captured by a UGC audio capture device such as binaural earbuds. The binaural audio signal 264 generally has 2 channels.

The binaural objects 266 generally correspond to audio data that the object extractor 210 has localized to an identified location in the audiovisual scene. For example, bird chirps or airplane noise may be extracted to generate height objects. Similarly, an identified sound originating to the left of the capture device may be extracted to generate a second audio object, and an identified sound originating to the right of the capture device may be extracted to generate a third audio object.

The residual signal 268 corresponds to the audio signal 262 and the binaural audio signal 264 excluding the binaural objects 266. The residual signal 268 has N+2 channels, corresponding to the N-channel residual of the audio signal 262 (that excludes the binaural objects 266) and the 2-channel residual of the binaural audio signal 264 (that excludes the binaural objects 266).

The object extractor 210 may implement a machine learning system to extract the binaural objects 266 from the audio inputs. In general, a machine learning system has a model that has been trained in a training phase using training data. During an operation phase, the machine learning system uses the model as part of processing input data in order to generate the output of the machine learning system.

According to an embodiment, the machine learning system implements a model trained based on the signal noise ratio (SNR) of a training audio data set. The model may have a number of sub-models or layers, and may be configured to process sparse objects. In operation, the machine learning system performs feature extraction on the audio inputs (e.g., including SNR features), performs classification on the extracted features, and uses the model as part of generating the binaural objects 266 based on the extracted features. The machine learning system may reduce or remove leakage from the classified objects by processing the extracted objects based on at least one of SNR or audio-visual context to generate the binaural objects 266. Additional details of this embodiment of the machine learning system are provided in International Patent Application No. PCT/CN2022/114613.

The object extractor 210 may be implemented by the capture device of the UGC content creator, such as a mobile telephone (e.g., the mobile telephone 104 of FIG. 1). For example, the mobile telephone may capture the audio signal 262 using its microphones, may receive the binaural signal 264 from earbuds (e.g., the earbuds 106) connected to the mobile telephone via e.g. a Bluetooth™ wireless connection, and may generate the binaural objects 266 locally.

Alternatively, the object extractor 210 may be implemented by a server device. Instead of generating the binaural objects 266 locally, the capture device (e.g., the mobile telephone 104) transmits the audio signal 262 and the binaural signal 264 to a server that generates the binaural objects 266. The UGC content creator may then receive the binaural objects 266 from the server for local playback on the capture device or on another device. Additionally, other users may receive the binaural objects 266 from the server for playback using their own playback devices (with the captured video, when that has also been transmitted to the server device).

Alternatively, the object extractor 210 may be implemented by a computer. Instead of generating the binaural objects 266 locally or uploading the captured signals to a server, the UGC content creator may connect the mobile telephone to a personal computer that generates the binaural objects 266. The UGC content creator may then play back the binaural objects 266 using the computer or other device for local playback. Additionally, the UGC content creator may upload the captured video and received binaural objects 266 to a server for other users for playback using their own playback devices.

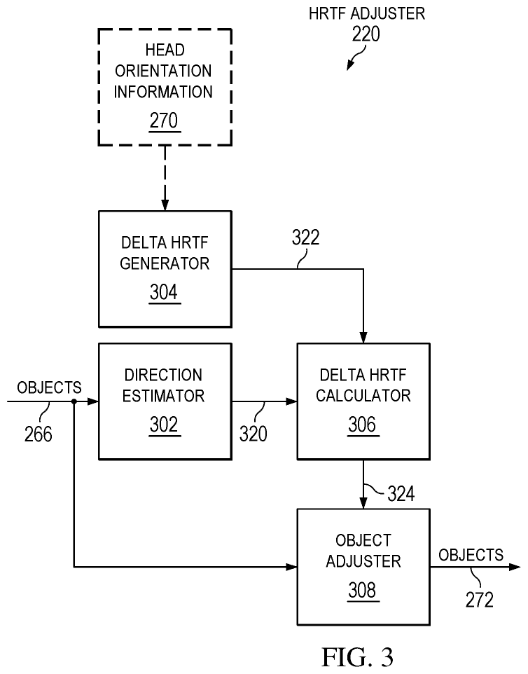

The HRTF adjuster 220 receives the binaural objects 266 and head orientation information 270, adjusts the binaural objects 266 in accordance with the head orientation information 270, and generates adjusted binaural objects 272. The head orientation information 270 may be generated by the playback device of the listener, for example by a binaural headset that has a gyroscope for tracking the movement of the headset as the listener's head moves. Accordingly, the adjusted binaural objects 272 correspond to the binaural objects 266, adjusted using HRTFs based on the head orientation information 270. Further details of the HRTF adjuster 220 are provided with reference to FIG. 3.

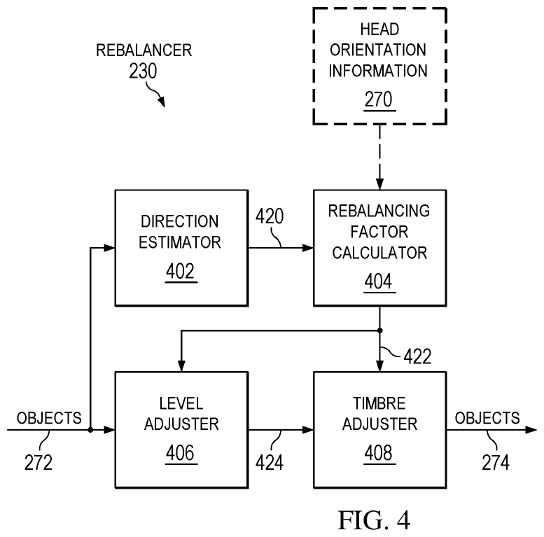

The rebalancer 230 receives the adjusted binaural objects 272 and the head orientation information 270, rebalances the adjusted binaural objects 272 in accordance with the head orientation information 270, and generates rebalanced binaural objects 274. In general, the rebalancer 230 performs level adjustment and timbre adjustment based on the listener's head movements, as indicated by the head orientation information 270. Further details of the rebalancer 230 are provided with reference to FIG. 4.

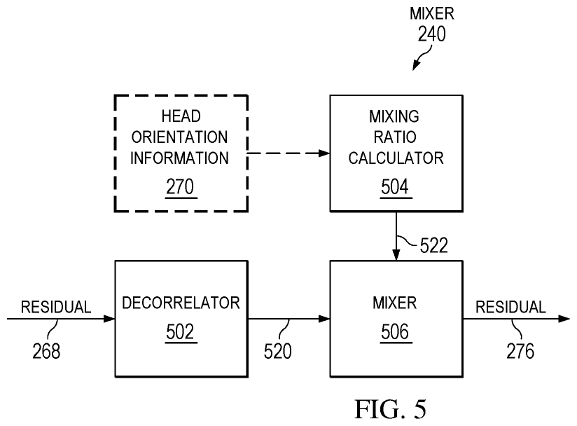

The mixer 240 receives the residual signal 268 and the head orientation information 270, mixes the residual signal 268 according to the head orientation information 270, and generates a residual signal 276. The residual signal 276 has 2 channels, as compared to the residual signal 268 that has N+2 channels. Further details of the mixer 240 are provided with reference to FIG. 5.

The remixer 250 receives the binaural objects 274 and the residual signal 276, mixes the audio corresponding to the binaural objects 274 with the residual signal 276, and generates a modified binaural signal 278. In general, the remixer 250 renders the binaural objects 274 into an interim binaural signal having two channels, to which it adds the residual signal 276 that also has two channels, resulting in the modified binaural signal 278 having two channels.

As discussed above, the functions of the system 200 may be implemented by multiple devices. As one example, the UGC content creator themselves may use their capture devices as the playback devices. In such an embodiment, the UGC content creator's mobile telephone is used to perform the object extraction, and the UGC content creator's earbuds are used to capture their head movements during playback. As another example, the UGC content creator may provide the captured video and processed audio to a listener, and the listener's device plays back the audio as modified by the listener's current head movements. In such an embodiment, the UGC content creator's mobile phone is used to perform the object extraction, and the listener's earbuds are used to capture the listener's current head movements. As another example, a server may perform the object extraction, for playback of the audio by the UGC content creator or another listener, as modified by their current head movements.

FIG. 3 is a block diagram showing additional details of the HRTF adjuster 220 (see FIG. 2). The HRTF adjuster 220 includes a direction estimator 302, a delta HRTF generator 304, a delta HRTF calculator 306, and an object adjuster 308. In general, the HRTF adjuster 220 adjusts mainly for azimuthal (leftward and rightward) changes in the listener's head orientation, but also for elevation (upward and downward) changes.

The direction estimator 302 receives the binaural objects 266, estimates a direction-of-arrival (DOA) for the sounds represented by the objects, and generates a weighting vector 320. The weighting vector 320 may correspond to TDOAs (time-delay-of-arrival) for the sounds represented by the objects. The direction estimator 302 may implement one or more techniques for estimating the DOA, including a digital signal processor (DSP)-based technique, a machine learning (ML)-based technique, etc. The DSP-based techniques may operate on level and time differences of the sounds represented by the objects. One example of a DSP-based technique is described in Kwon, Byoungho, Youngjin Park, and Youn-sik Park, “Analysis of the GCC-PHAT technique for multiple sources”, in ICCAS 2010, pp. 2070-2073 (IEEE, 2010)<doi: 10.1109/ICCAS.2010.5670137>. Another example of a DSP-based technique is described in Dmochowski, Jacek P., Jacob Benesty, and Sofiene Affes, “A generalized steered response power method for computationally viable source localization”, IEEE Transactions on Audio, Speech, and Language Processing 15, no. 8 (2007): 2510-2526 <doi: 10.1109/TASL.2007.906694>. One example of a ML-based technique is an adaptive boosting technique such as AdaBoost. Another example of a ML-based technique is a neural network with multiple layers between the input and output layers such as a deep neural network (DNN).

The delta HRTF generator 304 receives the head orientation information 270, adjusts the HRTFs calculated for a number of pre-defined locations according to the head orientation information 270, and generates delta HRTFs 322. The number of pre-defined locations may be four, corresponding to the front, back, left and right. The delta HRTFs 320 then correspond to the HRTFs of the pre-defined locations as adjusted according to the head orientation information 270. Using pre-defined locations reduces the computational complexity of generating the HRTFs based on the listener's head movements. The number of pre-defined locations may be adjusted as desired.

Equation (1) describes the operation of the delta HRTF generator 304.

$$dHRT {F}_{i} ( ω ) = \frac{H R T F ( ω , {θ}_{i} , + Δθ , {φ}_{i} + Δφ )}{H R T F ( ω , {θ}_{i} , {φ}_{i} )} \qquad ( 1 )$$

In Equation (1), w is the angular frequency, as the HRTF is frequency-dependent. θᵢ and φᵢ are respectively the azimuthal angle and the elevation angle of the i-th pre-defined location. Δθ and Δφ are respectively the azimuthal angle change and the elevation angle change due to the head rotation, according to the head rotation information 270. In other words, the delta HRTFs 322 for a given pre-defined location are proportional to a function of at least one of an azimuthal angle and an elevation angle of the given pre-defined location after head rotation, and inversely proportional to a function of at least one of the azimuthal angle and the elevation angle of the given pre-defined location.

The delta HRTF calculator 306 receives the weighting vector 320 and the delta HRTFs 322, applies the weighting vector 320 to the delta HRTFs 322 for the pre-defined locations, and generates weighted delta HRTFs 324. Equation (2) describes the operation of the delta HRTF calculator 306.

$$dHRT F ( ω ) = {\sum }_{i} {W}_{i} dHRT {F}_{i} ( ω ) \qquad ( 2 )$$

In Equation (2), Wᵢ is the weighting vector for the i-th pre-defined location. In other words, the weighted delta HRTFs 324 are the sum over the set of pre-defined locations of the weighting vector 320 applied to the delta HRTFs 322 for each pre-defined location.

The object adjuster 308 receives the binaural objects 266 and the weighted delta HRTFs 324, applies the weighted delta HRTFs to each object, and generates the adjusted binaural objects 272. Thus, the adjusted binaural objects 272 correspond to the binaural objects 266 rotated in accordance with the head orientation information 270. Equation (3) describes the operation of the object adjuster 308.

$${Y}_{obj \_ HA} ( ω ) = {X}_{o b j} ( ω ) dHRT F ( ω ) \qquad ( 3 )$$

In Equation (3), X_{obj}(ω) is a frequency-domain representation of a given object obj, dHRTF(ω) is the weighted delta HRTFs 324, and Y_{obj_HA}(ω) is a frequency-domain representation of the object after HRTF adjustment in accordance with the head orientation information 270. In other words, the adjusted binaural objects 272 are proportional to the weighted delta HRTFs 324.

In summary, the HRTF adjuster 220 calculates the DOA of each object (using the direction estimator 302) generated by the object extractor 110, then weights the HRTF of each object between two of the pre-defined locations using the object adjuster 308.

The playback device (e.g., the mobile telephone of the listener) may implement all the components of the HRTF adjuster 220. Alternatively, the capture device (e.g., the mobile telephone of the UGC content creator) may implement the direction estimator 302, with the playback device implementing the other components. In such an embodiment, the capture device may provide the weighting vector 320 to the playback device with the binaural objects 266, for example as metadata.

FIG. 4 is a block diagram showing additional details of the rebalancer 230 (see FIG. 2). The rebalancer 230 includes a direction estimator 402, a rebalancing factor calculator 404, a level adjuster 406, and a timbre adjuster 408. In general, the rebalancer 230 adjusts for elevation (upward and downward) changes in the listener's head orientation, for example related to height objects (airplanes, bird chirps, etc.).

The direction estimator 402 receives the adjusted binaural objects 272, estimates a direction-of-arrival (DOA) for the sounds represented by the objects, and generates a weighting vector 420. The direction estimator 402 may be the same component as the direction estimator 302 (see FIG. 3), in which case the weighting vector 420 corresponds to the weighting vector 320 calculated based on the binaural objects 266. Alternatively, the direction estimator 402 is a different component than the direction estimator 302, in which case the weighting vector 420 is calculated based on the adjusted binaural objects 272. In either case, the direction estimator 402 may perform direction estimation using similar techniques as those of the direction estimator 302, such as DSP-based techniques and ML-based techniques.

The rebalancing factor calculator 404 receives the weighting vector 420 and the head orientation information 270 and generates a steering factor 422. Equation (4) describes the operation of the rebalancing factor calculator 404.

$${g}_{Rebalance} = {g}_{d} σ ( Δφ ) \qquad ( 4 )$$

In Equation (4), g_{d} is the directional factor of a given object, as calculated by the direction estimator 402, and corresponds to the weighting vector 420. Δφ is the elevation angle change resulting from the listener's head movements and corresponds to the head orientation information 270. σ(·) is an activation function; the rebalancer 230 may use the activation function to rebalance height objects when the listener moves their head upward, for example to apply a gain. g_{Rebalance} corresponds to the steering factor 422. In other words, the steering factor 422 is proportional to the weights in the weighting vector 420 and the activation function (related to the head orientation information 270).

The level adjuster 406 receives the adjusted binaural objects 272 and the steering factor 422, adjusts a level of the adjusted binaural objects 272 in accordance with the steering factor 422, and generates level adjusted binaural objects 424. The level adjuster 406 may implement the level adjustment using dynamic range control (DRC) applied to the objects. For example, if a height object is already loud (prior to adjustment), there is no need to apply much additional gain when the listener moves their head direction upward. In such a case, the steering factor 422 controls the aggressiveness of the DRC. The level adjuster 406 may adjust the amount of DRC based on psychoacoustic principles.

The timbre adjuster 408 receives the level adjusted binaural objects 424 and the steering factor 422, adjusts a timbre of the level adjusted binaural objects 424 in accordance with the steering factor 422, and generates the rebalanced binaural objects 274. The timbre adjuster 408 may implement the timbre adjustment using equalization applied to certain bands. For example, the timbre of sound changes when a listener moves their head direction upward, and the timbre adjustment may boost certain bands in such a case. In other words, when the listener perceives a height object and moves their head direction upward, the timbre adjustment results in the perception that the listener is looking directly at the height object, instead of the height object being perceived as above the listener. In such a case, the steering factor 422 controls the aggressiveness of the EQ. The bands adjusted by the timbre adjuster 408 may be selected based on psychoacoustic principles.

The playback device (e.g., the mobile telephone of the listener) may implement all the components of the rebalancer 230. Alternatively, the capture device (e.g., the mobile telephone of the UGC content creator) may implement the direction estimator 402, with the playback device implementing the other components. In such an embodiment, the capture device may provide the weighting vector 420 to the playback device with the binaural objects 266, for example as metadata.

FIG. 5 is a block diagram showing additional details of the mixer 240 (see FIG. 2). The mixer 240 includes a decorrelator 502, a mixing ratio calculator 504 and a mixer 506.

The decorrelator 502 receives the residual signal 268, performs decorrelation on the residual signal 268, and generates a decorrelated residual signal 520 resulting from the decorrelation. The residual signal 268 has N+2 channels and the decorrelated residual signal 520 has M channels, where M≥N+2. When M=N+2 the decorrelation operation may be skipped. However, generally increasing M provides more special perception to the listener, at the cost of increased processing time. The decorrelator may be implemented using a group of delay lines. Another example implementation of the decorrelator 502 is given in Kendall, Gary S., “The decorrelation of audio signals and its impact on spatial imagery”, Computer Music Journal 19, no. 4 (1995): 71-87.

The mixing ratio calculator 504 receives the head orientation information 270 and generates a mixing matrix 522 based on the head orientation information 270. The mixing matrix 522 has size M×2 and corresponds to the azimuthal angle change Δθ and elevation angle change Δφ due to head rotation, as indicated by the head orientation information 270.

The mixer 506 receives the decorrelated residual signal 520 and the mixing matrix 522, performs mixing, and generates the residual signal 276. The mixer 506 may perform mixing as described by Equation (5).

$${Y}_{r e s} ( ω ) = {W}_{r e s} ( Δθ , Δφ ) {X}_{r e s} ( ω ) \qquad ( 5 )$$

In Equation (5), Yᵣₑₛ(ω) is a frequency domain representation of the residual signal 276, Wᵣₑₛ(Δθ, Δφ) is the mixing matrix 522, and Xᵣₑₛ(ω) is a frequency domain representation of the decorrelated residual signal 520. In other words, the residual signal 276 is proportional to the decorrelated residual signal 520 (which is based on the residual signal 268) and is proportional to the mixing matrix 522 (which is based on the azimuthal and elevation angle changes due to head rotation).

### Example Device Architecture

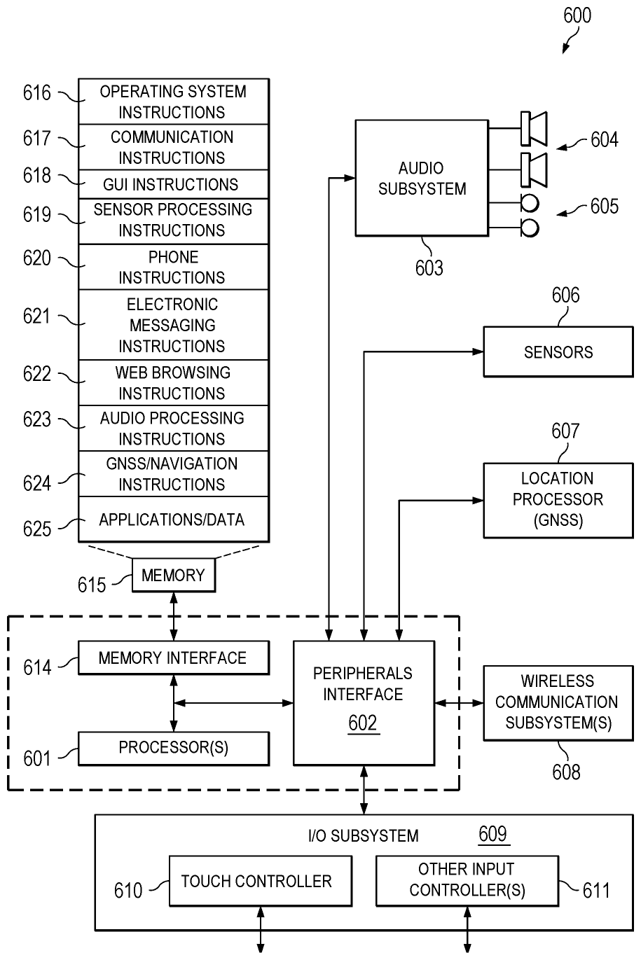

FIG. 6 is a device architecture 600 for implementing the features and processes described herein, according to an embodiment. The architecture 600 may be implemented in any electronic device, including but not limited to: a desktop computer, consumer audio/visual (AV) equipment, radio broadcast equipment, mobile devices, e.g. smartphone, tablet computer, laptop computer, wearable device, etc. In the example embodiment shown, the architecture 600 is for a mobile telephone. The architecture 600 includes processor(s) 601, peripherals interface 602, audio subsystem 603, one or more loudspeakers 604, one or more microphones 605, sensors 606, e.g. accelerometers, gyros, barometer, magnetometer, camera, etc., location processor 607, e.g. GNSS receiver, etc., wireless communications subsystems 608, e.g. Wi-Fi, Bluetooth, cellular, etc., and I/O subsystem(s) 609, which includes touch controller 610 and other input controllers 611, touch surface 612 and other input/control devices 613. Other architectures with more or fewer components can also be used to implement the disclosed embodiments.

Memory interface 614 is coupled to processors 601, peripherals interface 602 and memory 615, e.g., flash, RAM, ROM, etc. Memory 615 stores computer program instructions and data, including but not limited to: operating system instructions 616, communication instructions 617, GUI instructions 618, sensor processing instructions 619, phone instructions 620, electronic messaging instructions 621, web browsing instructions 622, audio processing instructions 623, GNSS/navigation instructions 624 and applications/data 625. Audio processing instructions 623 include instructions for performing the audio processing described herein.

According to an embodiment, the architecture 600 may correspond to one or more playback devices such as a mobile telephone and earbuds. In such an embodiment, the device architecture 600 corresponds to the mobile telephone and the audio subsystem 603 communicates wirelessly with the loudspeakers 604 implemented in the earbuds. The sensors 606 generate the head orientation information, for example by tracking the movement of the earbuds. The earbuds themselves may include components similar to those of the architecture 600 and output the binaural signal 278. The processor(s) 601 implement various functions of the system 200, such as the HRTF adjuster 220, the rebalancer 230, the mixer 240, the remixer 250, etc.

Similarly, the architecture 600 may correspond to one or more capture devices such as a mobile telephone and earbuds. In such an embodiment, the device architecture 600 corresponds to the mobile telephone and the audio subsystem 603 communicates wirelessly with the microphones 605 implemented in the earbuds. The earbuds themselves may include components similar to those of the architecture 600 and capture the binaural signal 264. The processor(s) 601 implement various functions of the system 200, such as the object extractor 210.

Similarly, the architecture 600 may correspond to a computer system implementing a cloud service. In such an embodiment, the device architecture 600 corresponds to the computer system that implements the object extractor 210. The computer system receives the audio signals 262 and 264 from the capture devices and transmits the binaural objects 266 and the residual signal 268 to the playback devices.

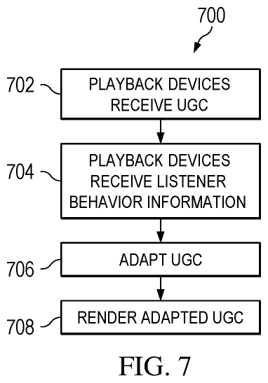

FIG. 7 is a flowchart of a method 700 of audio processing. The method 700 may be performed by one or more devices, e.g. a laptop computer, a mobile telephone, a server computer, etc., with the components of the architecture 600 of FIG. 6, to implement the functionality of the system 200 (see FIG. 2), etc., for example by executing one or more computer programs.

At 702, one or more playback devices receive user generated content (UGC) captured by capture devices that are connected to one another. Each audio source of the UGC corresponds to respective characteristics in an audio scene. For example, the mobile telephone 104 (see FIG. 1) and the earbuds 106 may be connected wirelessly, with the mobile telephone 104 capturing UGC video and UGC audio, and the earbuds 106 capturing UGC binaural audio. A playback device (e.g., a mobile telephone and earbuds of a listener) may receive the captured UGC.

At 704, the one or more playback devices receive from one or more sensors of the one or more playback devices, information indicating listener behavior of a user of the one or more playback devices. For example, the playback device may be implemented by the architecture 600 (see FIG. 6) in which the sensors 606 include a gyroscope that generates head orientation information corresponding to the listener's head movements.

At 706, the UGC is adapted according to the listener behavior, including compensating the characteristics of audio sources according to the listener behavior. For example, the playback device may implement the system 200 (see FIG. 2) that adjusts the captured UGC audio (the audio signal 262 and the binaural audio signal 264) according to the head orientation information 270.

At 708, the adapted UGC (see 706) is rendered to provide an interactive experience to the listener with regard to the audio scene. For example, the playback device may implement the remixer 250 (see FIG. 2) that renders the results of adapting the captured UGC audio and generates the modified binaural signal 278.

The method 700 may include additional steps corresponding to the other functionalities of the audio processing systems as described herein. One such functionality is object modification, e.g. using the HRTF adjuster 220 or the rebalancer 230 (see FIGS. 2-4). The HRTF adjustments may include extracting one or more objects from a given audio portion of the UGC, for example as described herein regarding the object extractor 210 (see FIG. 2). The HRTF adjustments may include calculating HRTF differences before and after head rotation for a group of pre-defined locations, for example as described herein regarding the delta HRTF generator 304 (see FIG. 3). The HRTF adjustments may include obtaining a HRTF difference for a particular object by applying different weights to the HRTF differences for the group of pre-defined locations according to a respective direction of each of the one or more objects, for example as described herein regarding the direction estimator 302 and the delta HRTF calculator 306 (see FIG. 3). The HRTF adjustments may include relocating the particular object to the new location after head rotation, including applying the obtained HRTF difference to the particular object, for example as described herein regarding the object adjuster 308 (see FIG. 3).

The rebalancing may include extracting one or more objects from a given audio portion of the UGC, for example as described herein regarding the object extractor 210 (see FIG. 2). The rebalancing may include determining a respective orientation of each of the one or more objects, for example as described herein regarding the direction estimator 402 and the rebalancing factor calculator 404 (see FIG. 4). The rebalancing may include rebalancing the objects according to head orientation information by applying at least one of level adjustment and timbre adjustment, for example as described herein regarding the level adjuster 406 and the timbre adjuster 408 (see FIG. 4).

Another such functionality is residual mixing, e.g. using the mixer 240 (see FIGS. 2 and 5). The residual mixing may include obtaining a residual by removing objects from a given audio portion of the UGC, for example as described herein regarding the object extractor 210 to generate the residual signal 268 (see FIG. 2). The residual mixing may include creating one or more additional channels by decorrelation, for example as described herein regarding the decorrelator 502 (see FIG. 5). The residual mixing may include mixing the residual from different audio channels of different capture devices by applying a mixing ratio for each channel, according to head orientation information, for example as described herein regarding the mixing ratio calculator 504 and the mixer 506 (see FIG. 5).

### Implementation Details

An embodiment may be implemented in hardware, executable modules stored on a computer readable medium, or a combination of both, e.g. programmable logic arrays, etc. Unless otherwise specified, the steps executed by embodiments need not inherently be related to any particular computer or other apparatus, although they may be in certain embodiments. In particular, various general-purpose machines may be used with programs written in accordance with the teachings herein, or it may be more convenient to construct more specialized apparatus, e.g. integrated circuits, etc., to perform the required method steps. Thus, embodiments may be implemented in one or more computer programs executing on one or more programmable computer systems each comprising at least one processor, at least one data storage system, including volatile and non-volatile memory and/or storage elements, at least one input device or port, and at least one output device or port. Program code is applied to input data to perform the functions described herein and generate output information. The output information is applied to one or more output devices, in known fashion.

Each such computer program is preferably stored on or downloaded to a storage media or device, e.g., solid state memory or media, magnetic or optical media, etc., readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. Software per se and intangible or transitory signals are excluded to the extent that they are unpatentable subject matter.

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical, non-transitory, non-volatile storage media in various forms, such as optical, magnetic or semiconductor storage media.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

1. A computer-implemented method of audio processing, the method comprising:
receiving, by one or more playback devices, user generated content (UGC) captured by capture devices that are connected to one another, each audio source of the UGC corresponding to respective characteristics in an audio scene;
receiving, by the one or more playback devices from one or more sensors of the one or more playback devices, information indicating listener behavior of a user of the one or more playback devices;
adapting the UGC according to the listener behavior, including compensating the characteristics of audio sources according to the listener behavior; and
rendering the adapted UGC to provide an interactive experience to the listener with regard to the audio scene.

2. The method of claim 1, wherein the UGC comprises a video stream and an immersive audio stream.

3. The method of claim 1, wherein the one or more playback devices comprise a device for video playback and a connected device for audio playback.

4. The method of claim 1, wherein the capture devices comprise a first device capturing video and at least one channel of audio stream, and a connected device capturing a binaural audio stream.

5. The method of claim 1, wherein the listener behavior comprises at least a head orientation with respect to a screen of the one or more playback devices that is configured for video playback.

6. The method of claim 1, wherein adapting the UGC comprises at least one of object modification and residual mixing.

7. The method of claim 6, wherein the object modification comprises at least one of head related transfer function (HRTF) adjustments and object rebalancing.

8. The method of claim 7, wherein the HRTF adjustments comprise actions including:
extracting one or more objects from a given audio portion of the UGC;
calculating HRTF differences before and after head rotation for a group of pre-defined locations;
obtaining a HRTF difference for a particular object by applying different weights to the HRTF differences for the group of pre-defined locations according to a respective direction of each of the one or more objects; and
relocating the particular object to the new location after head rotation, including applying the obtained HRTF difference to the particular object.

9. The method of claim 7, wherein the object rebalancing comprises actions including:
extracting one or more objects from a given audio portion of the UGC;
determining a respective orientation of each of the one or more objects;
rebalancing the one or more objects according to head orientation information by applying at least one of level adjustment and timbre adjustment.

10. The method of claim 6, wherein the residual mixing comprises actions including:
obtaining a residual by removing objects from a given audio portion of the UGC;
creating one or more additional channels by decorrelation; and
mixing the residual from different audio channels of different capture devices by applying a mixing ratio for each channel, according to head orientation information.

11. The method of any one of claims 1-5, wherein adapting the UGC includes:
receiving one or more objects and a residual signal, wherein the one or more objects and the residual signal have been generated based on a given audio portion of the UGC, wherein the given audio portion of the UGC includes a first audio signal having at least one channel and a second audio signal being a binaural audio signal;
performing object modification on the one or more objects based on head orientation information, wherein performing the object modification includes generating one or more modified objects;
performing residual mixing on the residual signal based on the head orientation information, wherein performing the residual mixing includes generating a mixed residual signal; and
remixing the one or more modified objects and the mixed residual signal, including generating a modified binaural signal based on the one or more modified objects and the mixed residual signal.

12. The method of claim 11, further comprising:
extracting the one or more objects and the residual signal from the given audio portion of the UGC.

13. The method of claim 11, wherein performing the object modification includes:
performing direction estimation to calculate a direction of arrival for each object of the one or more objects;
performing HRTF adjustment, for each object of the one or more objects, to adjust a given object for at least one of an azimuthal change and an elevation change in the head orientation information based on a corresponding direction of arrival; and
performing object rebalancing, for each object of the one or more objects, to adjust the given object for the elevation change in the head orientation information based on the corresponding direction of arrival.

14. The method of claim 13, wherein the HRTF adjustment is based on a ratio proportional to a function of at least one of an azimuthal angle of a pre-defined location after the azimuthal change in the head orientation information and an elevation angle of the pre-defined location after the elevation change in the head orientation information, and inversely proportional to a function of at least one of an azimuthal angle and an elevation angle of the pre-defined location.

15. The method of claim 13, wherein the object rebalancing is proportional to a weighting vector and proportional to an activation function, wherein the weighting vector is based on a direction of the given object, and wherein the activation function is based on the elevational change in the head orientation information.

16. The method of claim 11, wherein performing the residual mixing includes:
performing decorrelation on the residual signal, wherein performing the decorrelation includes generating a decorrelated residual signal;
generating a mixing matrix based on an azimuthal angle change and an elevation angle change in the head orientation information; and
mixing, in a frequency domain, the decorrelated residual signal and the mixing matrix, including generating the mixed residual signal.

17. The method of claim 16, wherein the mixed residual signal is proportional to the mixing matrix and proportional to the decorrelated residual signal.

18. A non-transitory computer readable medium storing a computer program that, when executed by a processor, controls an apparatus to execute processing including the method of claim 1.

19. An apparatus for audio processing, the apparatus comprising:
a processor, wherein the processor is configured to control the apparatus to execute processing including the method of claim 1.

20. The apparatus of claim 19, wherein the one or more playback devices include:
a mobile telephone that includes the processor; and
a set of binaural earbuds.
